(19) United States
(12) Patent Application Publication
(10) Pub. No.: US 2009/0316882 A1
(43) Pub. Date: Dec. 24, 2009

(54) COMMUNICATION TERMINAL, METHOD FOR OPERATING COMMUNICATION TERMINAL, AND COMPUTER PROGRAM

(75) Inventor: Ido DE HAAN, Va Emmen (NL)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/141,488

(22) Filed: Jun. 18, 2008

(51) Int. Cl. H04M 9/00

(52) U.S. Cl. 379/433.06

(57) ABSTRACT

A communication terminal is disclosed, comprising a first audio input/output element arranged in vicinity of a first end of a body of the communication terminal;
a second audio input/output element arranged in vicinity of a second end of the body of the communication terminal; an accelerometer arranged to determine force applied on a mass in the communication terminal, wherein the first and second audio input/output elements are each arranged for selectable performance as microphone or speaker such that depending on the determined force on the mass, one of the first and second audio input/output elements is assigned for speaker operation, and the other for microphone operation. A method and computer program are also disclosed.

### TECHNICAL FIELD

The present invention relates to a communication terminal, a method for operating the communication terminal, and a computer program for implementing the method.

### BACKGROUND

Communication terminals are appreciated when relatively small and easy to use. Many times they are used without looking at them and operated swiftly. If the body of the communication apparatus is more or less symmetrical in one or more directions, the orientation of the communication terminal can be hard to determine by the user without looking at the communication terminal, and especially when swiftly handled. The user may during such operation get the communication terminal in a wrong orientation for use. Therefore, there is a need to improve swift operation of communication terminals such that the user is able to handle the communication terminal without needing to look at the communication terminal.

### SUMMARY

An object of the invention is to at least alleviate the above stated problem. The present invention is based on the understanding that

According to a first aspect, there is provided a communication terminal comprising a first audio input/output element arranged in vicinity of a first end of a body of the communication terminal; a second audio input/output element arranged in vicinity of a second end of the body of the communication terminal; an accelerometer arranged to determine force applied on a mass in the communication terminal, wherein the first and second audio input/output elements are each arranged for selectable performance as microphone or speaker such that depending on the determined force on the mass, one of the first and second audio input/output elements is assigned for speaker operation, and the other for microphone operation.

The communication terminal may further comprise a processor arranged to process an output signal from the accelerometer to assign operation for the first and second audio input/output elements.

The communication terminal may be a mobile phone, a headset, or a handset.

The accelerometer may be a microelectromechanical system accelerometer.

According to a second aspect, there is provided a method for operating a communication terminal comprising a first audio input/output element arranged in vicinity of a first end of a body of the communication terminal and a second audio input/output element arranged in vicinity of a second end of the body of the communication terminal. The method comprises determining orientation of the communication terminal; assigning one of the first and second audio input/output elements for speaker operation, and the other for microphone operation based on the determined orientation.

The determining of the orientation may comprise determining a force on a mass in the communication terminal, wherein the determination of the force is performed by an accelerometer.

The method may comprise determining if a component of the force along a line between the first and second audio input/output elements is directed towards the first or second audio input/output element, wherein the one of the first and second audio input/output elements towards which the component of the force is directed is assigned to be operated as microphone.

According to a third aspect, there is provided a computer-readable medium comprising program code comprising instructions which when executed by a processor, in a communication terminal comprising a first audio input/output element arranged in vicinity of a first end of a body of the communication terminal and a second audio input/output element arranged in vicinity of a second end of the body of the communication terminal, is arranged to cause the processor to perform determination of orientation of the communication terminal; assignment of one of the first and second audio input/output elements for speaker operation, and the other for microphone operation based on the determined orientation.

The instructions may be arranged such that determining of the orientation comprise determining a force on a mass in the communication terminal, the determination of the force is performed by an accelerometer, the assignment of operations comprises determining if a component of the force along a line between the first and second audio input/output elements is directed towards the first or second audio input/output element, and the one of the first and second audio input/output elements towards which the component of the force is directed is assigned to be operated as microphone.

According to a fourth aspect, there is provided a computer program arranged to, when executed by a processor, cause the processor to perform the method according to the second aspect.

### BRIEF DESCRIPTION OF DRAWINGS

FIG. 1 illustrates a communication terminal according to an embodiment.

FIG. 2 is a flow chart schematically illustrating a method according to an embodiment.

FIG. 3 schematically illustrates a computer-readable medium for storage of program code.

### DETAILED DESCRIPTION

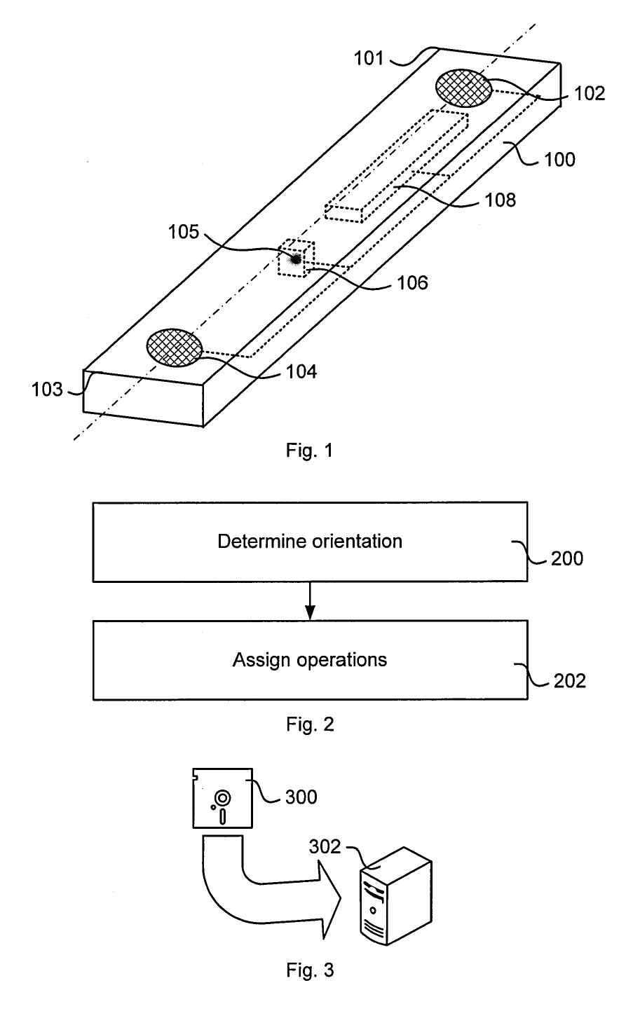

FIG. 1 illustrates a communication terminal 100 according to an embodiment. The communication terminal comprises one audio input/output element 102, 104 arranged in vicinity of each end 101, 103 of a body of the communication terminal 100. The audio input/output elements 102, 104 are able to operate both as speaker and microphone. Thereby, a user is able to hold the communication terminal in a normal way, as well as in an upside-down way, e.g. when answering a call, the user do not have to consider which end to put towards the ear and towards the mouth, respectively. The communication terminal 100 automatically determining the actual orientation of the body enables this. By an accelerometer 106, i.e. a device measuring or detecting a force on a mass 105, the orientation can be determined. From this determination, one of the audio input/output elements 102, 104 is assigned to operate as a microphone, and the other one as a speaker. Optionally, the determination and assignment is performed with aid of a processor 108. An output signal from the accelerometer 106 is thus provided to the processor 108, which makes an estimate of the orientation and thus of the way the user is using the communication terminal 100. Out of this, the processor 108 control assignment of operation modes of the audio input/output elements 102, 104. For example, the direction of the force of gravity on the mass 105 is determined, wherein a component of the force in a direction along a line (dot-dashed) between the audio input/output elements 102, 104 is determined such that the one of the audio input/output elements 102, 104 towards which the component of the force is directed is assigned to be operated as microphone. This is based on the assumption that the communication apparatus is held such that the mouth end is lower than the ear end. Other ways of determining use of the communication terminal, based on static force or dynamic patterns of forces on the mass 105, can also be applied.

The communication terminal 100 can for example be a mobile telephone, a handset, or a headset. The communication terminal 100 can be arranged for wireless communication. The communication terminal 100 can further comprise means for communication such as antenna, receiver, transmitter, and signal processing means. The communication terminal 100 can also comprise further user interface elements such as display, one or more keys, vibrator, and further input means such as scroll wheels, joystick, etc. These are not illustrated not to obscure the particular elements involved in the inventive concept.

The accelerometer 106 can for example be a microelectromechanical system (MEMS) accelerometer, which is both a small and low-cost element and robust in operation. The accelerometer 106 can be arranged to operate in one, two, or three dimensions. If only the component of the force on the mass along the dot-dashed line is used for determining orientation and thus assignment of operation of the audio input/output elements 102, 104, only a one-dimension accelerometer is needed wherein the accelerometer 106 is arranged to determining the force on the mass 105 along this line. For the other approaches, i.e. other static or dynamic models for determining the way the communication terminal 100 is used, two or three dimension accelerometers can be used. The accelerometer 106 can also be used for other input operations of the communication apparatus 100.

FIG. 2 is a flow chart schematically illustrating a method, for operating a communication terminal comprising a first audio input/output element arranged in vicinity of a first end of a body of the communication terminal and a second audio input/output element arranged in vicinity of a second end of the body of the communication terminal, according to an embodiment. In an orientation determination step 200, the orientation of the communication terminal is determined. Then, in a operations assignment step 202, one of the audio input/output elements is assigned for speaker operation, and the other for microphone operation. This is based on the determined orientation. The determined orientation can be a static state, or based on a dynamic handling of the communication terminal. The orientation determination can comprise determining a force on a mass in the communication terminal, which force is determined by an accelerometer of the communication terminal. This can be performed by the assigning of operations based on determination if a component of the force along a line between the first and second audio input/output elements is directed towards the first or second audio input/output element, wherein the one of the first and second audio input/output elements towards which the component of the force is directed is assigned to be operated as microphone. As elucidated above, this can alternatively be performed by observing a dynamic process, e.g. where the user moves the communication terminal into position for communication.

The methods according to the present invention is suitable for implementation with aid of processing means, such as computers and/or processors, especially for the case where a dynamic process is observed. Therefore, there is provided computer programs, comprising instructions arranged to cause the processing means, processor, or computer to perform the steps of any of the methods according to any of the embodiments described with reference to FIG. 2. The computer programs preferably comprises program code which is stored on a computer readable medium 300, as illustrated in FIG. 3, which can be loaded and executed by a processing means, processor, or computer 302 to cause it to perform the methods, respectively, according to embodiments of the present invention, preferably as any of the embodiments described with reference to FIG. 2. The computer 302 and computer program product 300 can be arranged to execute the program code sequentially where actions of the any of the methods are performed stepwise, or be performed on a real-time basis, where actions are taken upon need and availability of needed input data. The processing means, processor, or computer 302 is preferably what normally is referred to as an embedded system. Thus, the depicted computer readable medium 300 and computer 302 in FIG. 3 should be construed to be for illustrative purposes only to provide understanding of the principle, and not to be construed as any direct illustration of the elements.

1. A communication terminal comprising
a first audio input/output element arranged in vicinity of a first end of a body of the communication terminal;
a second audio input/output element arranged in vicinity of a second end of the body of the communication terminal;
an accelerometer arranged to determine force applied on a mass in the communication terminal,
wherein the first and second audio input/output elements are each arranged for selectable performance as microphone or speaker such that depending on the determined force on the mass, one of the first and second audio input/output elements is assigned for speaker operation, and the other for microphone operation.

2. The communication terminal according to claim 1, further comprising a processor arranged to process an output signal from the accelerometer to assign operation for the first and second audio input/output elements.

3. The communication terminal according to claim 1, being a mobile phone, a headset, or a handset.

4. The communication apparatus according to claim 1, wherein the accelerometer is a microelectromechanical system accelerometer.

5. A method for operating a communication terminal comprising a first audio input/output element arranged in vicinity of a first end of a body of the communication terminal and a second audio input/output element arranged in vicinity of a second end of the body of the communication terminal, the method comprising
determining orientation of the communication terminal;
assigning one of the first and second audio input/output elements for speaker operation, and the other for microphone operation based on the determined orientation.

6. The method according to claim 5, wherein the determining of the orientation comprises determining a force on a mass in the communication terminal, wherein the determination of the force is performed by an accelerometer.

7. The method according to claim 6, comprising determining if a component of the force along a line between the first and second audio input/output elements is directed towards the first or second audio input/output element, wherein the one of the first and second audio input/output elements towards which the component of the force is directed is assigned to be operated as microphone.

8. A computer-readable medium comprising program code comprising instructions which when executed by a processor, in a communication terminal comprising a first audio input/output element arranged in vicinity of a first end of a body of the communication terminal and a second audio input/output element arranged in vicinity of a second end of the body of the communication terminal, is arranged to cause the processor to perform
determination of orientation of the communication terminal;
assignment of one of the first and second audio input/output elements for speaker operation, and the other for microphone operation based on the determined orientation.

9. The computer-readable medium according to claim 8, wherein the determining of the orientation comprises determining a force on a mass in the communication terminal, the determination of the force is performed by an accelerometer, the assignment of operations comprises determining if a component of the force along a line between the first and second audio input/output elements is directed towards the first or second audio input/output element, and the one of the first and second audio input/output elements towards which the component of the force is directed is assigned to be operated as microphone.
